(19) United States
(12) Patent Application Publication
(10) Pub. No.: US 2016/0007580 A1
(43) Pub. Date: Jan. 14, 2016

(54) HANDHELD FISHING NET FRAME

(71) Applicants: Kevin Best, Denver, CO (US); Shuo-Hung Hung, Taichung City (TW)

(72) Inventors: Kevin Best, Denver, CO (US); Shuo-Hung Hung, Taichung City (TW)

(21) Appl. No.: 14/796,436

(22) Filed: Jul. 10, 2015

Related U.S. Application Data
(60) Provisional application No. 62/023,286, filed on Jul. 11, 2014.

(51) Int. Cl. A01K 75/04; A01K 77/00

(52) U.S. Cl. CPC A01K 75/04; A01K 77/00

(57) ABSTRACT

A hand held fishing net frame comprising a composite fiber shell filled with a closed cell foam.

### RELATED APPLICATIONS

This application claims priority to U.S. Provisional Application Ser. No. 62/023,286, filed Jul. 11, 2014, entitled “An Improved Handheld Fishing Net Frame” and which is incorporated by reference in its entirety.

### BACKGROUND

Handheld fishing nets are typically carried by fishermen or women to aid the landing of fish caught with a rod and reel. These nets are often used on boats or as the fisherman or woman is walking in streams or rivers. Once a fish is hooked, the fishing net is retrieved and is used to scoop the hooked fish from the water. When fishing in streams or rivers, it is not uncommon for the net to strike underwater obstructions, such as large rocks. Additionally, larger fish create significant loads on the net frame. If the fisherman or woman is alone, the rod and reel will be in one hand and the other hand is used to retrieve and use the fishing net. In this setting, the excitement of catching the struggling fish, wet or cold hands and the unpredictability of a fish's response often result in dropped nets. Because handheld fishing nets may be carried, along with other fishing gear, by an individual traversing rugged and slippery terrain while following a stream or river and because it is more difficult to manipulate heavier handheld nets to capture hooked fish, lightweight nets are desirable.

Wooden framed handheld nets were known. If dropped, these nets would advantageously float. However, wooden framed nets were known to be somewhat heavy and were known to break if underwater obstructions were hit while scooping a fish from the water or even if larger fish were aggressively scooped. Wooden nets also deteriorate and delaminate when exposed to water and sunlight.

Metal-framed nets were also known. While metal-framed nets are known to be strong, they tend to be heavy and do not float. Metal nets also bend under the strain of heavy currents and large fish.

Composite fiber framed nets were also known. While the prior art composite fiber framed nets were strong, light and floated, their hollow frames could fill with water, which made them heavy and unwieldy. The prior art frames had apertures through which the rubberized net was attached. The apertures were formed by drilling through webbing joining two hollow tubes that formed the fishnet head frame. Drilling these apertures would often also create an opening into the hollow tubes, which would permit water to enter the tubes.

### SUMMARY OF THE INVENTION

The present invention addresses the problems in the prior art by providing a fishing net frame that is strong, buoyant and light and that minimizes water infiltration.

### BRIEF DESCRIPTION OF THE FIGURES

FIG. 1 is a perspective view of one embodiment of the present invention.

FIG. 2 is a cross-sectional view of the fishing net head frame of one embodiment of the present invention.

FIG. 3 is a cross-sectional view of the fishing net head frame of one embodiment of the present invention.

FIG. 4 is an enlarged view of a section of the fishing net head frame of one embodiment of the present invention.

### DETAILED DESCRIPTION

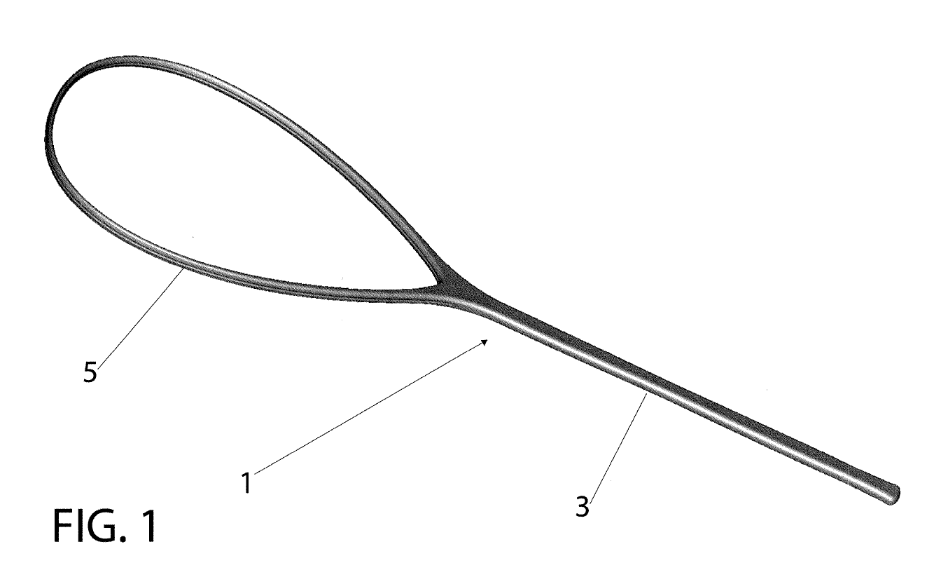

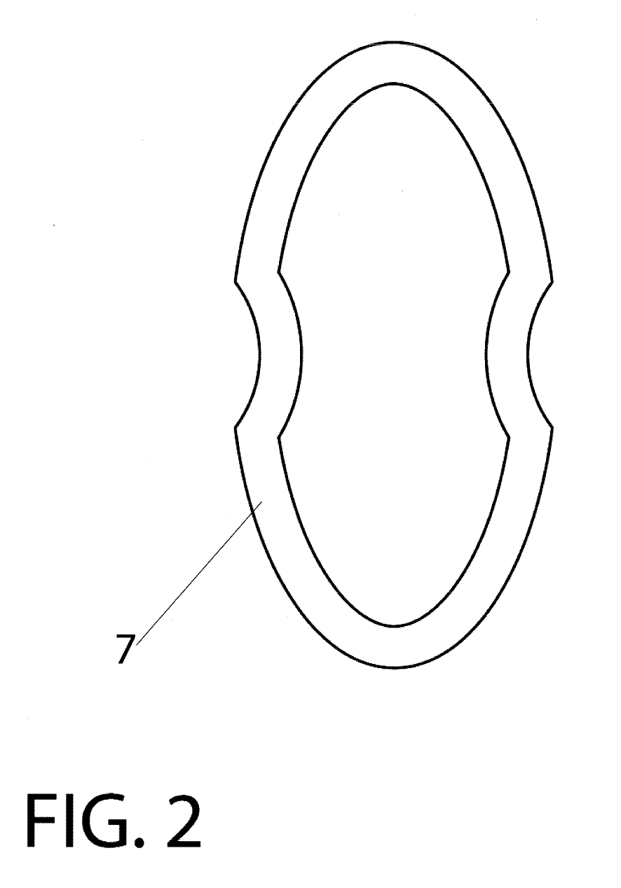

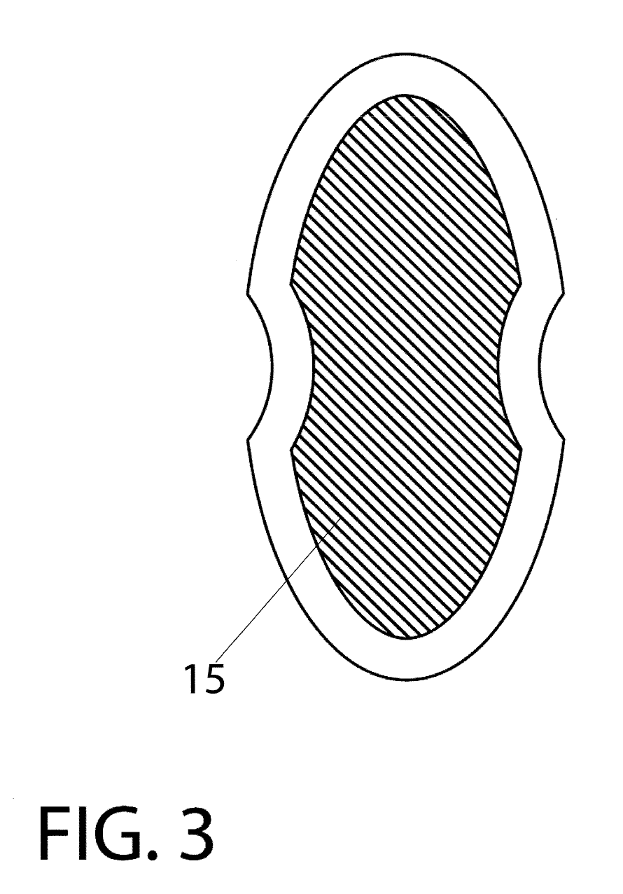

FIG. 1 depicts one embodiment of the present invention. The fishnet frame 1 comprises a handle 3 and a head frame 5. The handle 3 is generally hollow and is rigidly attached to the head frame 5. The head frame 5 of this embodiment comprises a composite fiber tube 7, as shown in FIG. 2. In one embodiment, the composite fiber tube 7 is filled with a closed cell foam 15, such as polyurethane foam, as illustrated in FIG. 3. This closed cell foam 15 may also fill the hollow handle. In one embodiment, the composite fiber tubes 7 are made of carbon fiber and or fiberglass and the handle 3 is made of carbon fiber and or fiberglass. The closed cell foam effectively fills the void within the hand held fishing net frame, which effectively precludes water from entering the previously defined void.

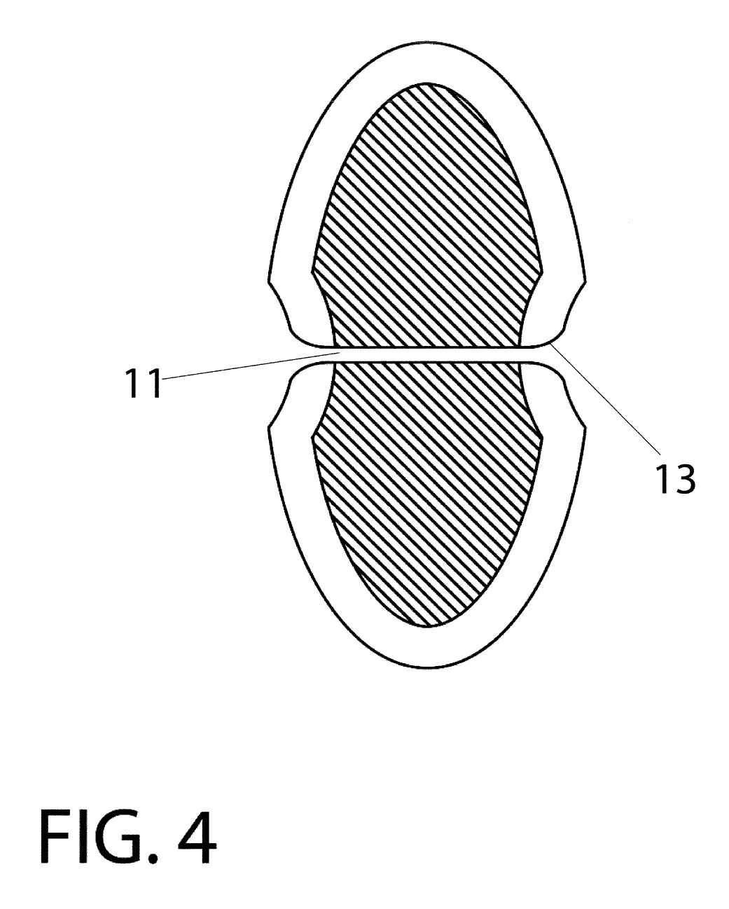

Apertures 11 are formed in head frame 5 such that a rubberized net (not shown) can be attached to head frame 5. In one embodiment, the aperture shoulder 13 is chamfer, as shown in FIG. 4, so that it will not abrade the connections to the rubberized net.

Changes may be made in the above methods and systems without departing from the scope hereof. For example, the cross-sectional shape of the head frame 5 can vary as can the composition of the materials used to make the head frame 5 and handle 3. Additionally, other light-weight materials, such as wood, polystyrene foam, may be used in place of the closed cell foam to fill the voids in the head frame 5 and handle 3. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A handheld fishing net frame comprising:
a handle;
a head frame, said head frame defining a void; and
a buoyant solid filling said void.

2. The hand held fishing net frame of claim 1 wherein said buoyant solid is a closed cell foam.

3. The hand held fishing net frame of claim 2 wherein said buoyant solid is polyurethane foam.

4. The hand held fishing net frame of claim 1 further comprising:
a plurality of apertures formed in said head frame, said apertures adapted to connect a rubberized net to said head frame.

5. The hand held fishing net frame of claim 3 wherein said apertures have a chamfered shoulder.

6. The hand held fishing net frame of claim 1 wherein said handle defines a void and said void is filled with a closed cell foam.

7. The hand held fishing net frame of claim 1 wherein said void in said head frame comprises a single compartment.

8. The hand held fishing net frame of claim 7 wherein said single compartment is an arcuate tube.
